(19) United States
(12) Patent Application Publication
(10) Pub. No.: US 2023/0014060 A1
(43) Pub. Date: Jan. 19, 2023

(54) SIDE-TYPE POWDER TOP BLOWN FURNACE AND METHOD FOR TREATING SAME

(71) Applicant: YUNNAN TIN CO. LTD. TIN BRANCH, Hongle (CN)

(72) Inventors: Xingcheng SONG, Honghe (CN); Duzuo TANG, Honghe (CN); Zhang ZHANG, Honghe (CN); Haibin YUAN, Honghe (CN); Qingdong LIU, Honghe (CN); Wanli XU, Honghe (CN); Chi ZHANG, Honghe (CN); Jianwei WANG, Honghe (CN); Yun CHEN, Honghe (CN); Yumei ZHANG, Honghe (CN)

(21) Appl. No.: 17/693,325

(22) Filed: Mar. 12, 2022

Related U.S. Application Data
(63) Continuation of application No. PCT/CN2022/075951, filed on Feb. 11, 2022.

(30) Foreign Application Priority Data
Jul. 16, 2021 (CN) 202110806443X

(51) Int. Cl. F27B 15/08; F27B 1/26; F27B 1/20; F27B 15/18

(52) U.S. Cl. CPC F27B 15/08; F27B 1/26; F27B 1/20; F27B 15/18; F27M 2003/13; F27M 2001/01; F27M 2001/16

(57) ABSTRACT

A side-type powder top blown furnace and method for treating the furnace is disclosed. The furnace includes a cylindrical furnace body, powder material inlet nozzles, a furnace top sample rod, a top blown furnace spray gun, a belt feeding inlet, a branch conveying pipe, a quantitative pneumatic conveying device, a powder material collecting bin, a powder collecting bin feeding inlet and a furnace top cover; the powder material inlet nozzles are symmetrically arranged around a furnace wall of the cylindrical furnace body on the same horizontal plane. The disclosure can solve the problems of large transportation flying loss, large return amount, poor operating environment, harm to the health of operators and the like in the tin smelting process.

### TECHNICAL FIELD

The present disclosure relates to the technical field of pyrometallurgical smelting of crude tin, and more particularly to a side-type powder top blown furnace and method for treating the top blown furnace.

### BACKGROUND ART

In large-scale tin smelter, top blown furnace with high hearth capacity is generally selected as tin smelt equipment, and the tin materials to be treated mainly include tin concentrate, tin calcine after roasting arsenic and sulfur removal, tin dust powder obtained after fuming, volatilizing low tin material in fuming furnace, and the tin powder dust and dust collected in the tail gas system during the smelting process of the top blown furnace. Wherein, the calcine and dust materials are fine in size and low in moisture, which is easy to cause flying loss in the process of transportation and feeding. These materials with small particle size and low water content can be collectively referred to as powdery tin materials, and this kind of materials account for about 40˜60% of the total input tin materials in the tin smelting system, accounting for a relatively large proportion, and the optimization of its treatment method is of great significance for reducing costs and increasing efficiency and improving the operating environment of tin smelters, and it is worthy of further exploration.

In the production process of the current large-scale tin smelter, all tin-containing materials are transported by belts and are put into the top-blown smelting furnace from the top of the furnace for reduction smelting to produce coarse tin, the tin-containing materials with low moisture and small particle size also need to be granulated with water, and the moisture content of the mixture materials entering the furnace generally needs to reach about 10%. If a large amount of water is mixed into that material fed into the furnace, not only the capacity of the smelting furnace bed is reduced, but also the smelting energy consumption is increased, and the flue gas produced in the smelting process is accompanied by a large amount of high-temperature steam, In that follow-up flue gas treatment system, the treatment difficulty and the treatment cost are increased. As the types and components of the tin-containing materials processed by the smelter are complex, it is usually necessary to carry out pretreatment before smelting to produce various tin-containing powder materials, for example, tin-containing powder materials produced by boiling furnace roasting, tin-containing dust produced by fuming furnace, tin-containing dust produced by other smelting furnaces and other tin-containing powder materials; the above kinds of tin-containing powder materials need to be pneumatically conveyed or transported to the ore bin by truck, and then, after being distributed in front of the furnace, transported to the top blowing furnace by belt for smelting. Therefore, it is inevitable that all kinds of tin-containing powder materials will suffer losses such as spilling, material leakage and flying during the process of transporting tin-containing powder materials into the smelting furnace by the top belt, the falling stroke of tin-containing powder materials in the smelting furnace is long, and it is easy to enter the tail gas dust collection system along with the furnace flue gas, and then enter the batching process, which increases the return amount of materials in the smelting process, and increases the material losses during the return process, reduces the direct yield and recovery rate of tin smelting, and raises the smelting cost.

In order to solve the above problems existing in the smelting process of tin-containing powder materials, such as increasing smelting energy consumption, increasing the burden of tail gas treatment system, metal loss and poor operating environment caused by dust flying due to bad luck, and reducing the comprehensive recovery rate of tin smelting, it is urgent to develop a classified disposal method for tin-containing powder materials in the field of tin smelting, so as to achieve the effects of clean operating environment, high direct recovery rate of tin smelting and green energy saving.

Therefore, it is an urgent problem for technicians in this field to provide a clean, environment-friendly and efficient treatment method for powdered tin materials.

### SUMMARY

In view of this, the disclosure provides a side-type powder top blown furnace and method for treating the top blown furnace, which can solve the problems of large transportation flying loss, large amount of returned materials, poor operating environment, harm to the health of operators and the like in the tin smelting process.

In order to achieve the above objective, the technical scheme adopted by the present disclosure is as follows:

a side-type powder top blown furnace includes a cylindrical furnace body, powder material inlet nozzles, a furnace top sample rod, a top blown furnace spray gun, a belt feeding inlet, a branch conveying pipe, a quantitative pneumatic conveying device, a powder material collecting bin, a powder collecting bin feeding inlet and a furnace top cover;

the powder material inlet nozzles are symmetrically arranged around a furnace wall of the cylindrical furnace body on the same horizontal plane, and the powder material inlet nozzles are at an angle of 45 degrees with the furnace wall, and the center of the nozzle faces the center line of the furnace bottom;

the top of the cylindrical furnace body is provided with a furnace top cover, the top blown furnace spray gun passes through the center of the furnace top cover and extends into the bottom of the cylindrical furnace body; the furnace top sample rod extends into the bottom of the cylindrical furnace body through the furnace top cover; the belt feeding inlet is arranged on the furnace top cover;

the top of the powder material collecting bin is provided with a powder material collecting bin feeding inlet, and the bottom of the powder material collecting bin is connected with the quantitative pneumatic conveying device, the quantitative pneumatic conveying device is connected with the powder material inlet nozzle through the branch conveying pipe.

Preferably, the vertical positions of the two symmetrically opposite corresponding nozzles of the powder material inlet nozzles are arranged on the horizontal plane of the slag line with the maximum treatment capacity of the top blown furnace.

Preferably, the number of the powder material inlet nozzles can be selected as other even numbers.

Preferably, the powder material collecting bin feeding inlet receives the powdery tin material and the fine coal of different sections in different sections in the tin smelting process, and the powder material collecting bin feeding inlet respectively corresponds to the powdery materials of different sources.

Preferably, the powder material collecting bin is further provided with a DCS control system for setting an unit time and a conveying speed, and powdery materials are fed into the powder material collecting bin of powdery materials by means of quantitative pneumatic conveying to complete mixing.

Preferably, the conveying speed of the quantitative pneumatic conveying device (7) is 10-35 t/h and the conveying pressure is 0.6-0.9 MPa.

A method for treating a top blown furnace, the specific steps are as follows: setting parameters of DCS control system, feeding a powder tin dust, a powder coal and a powder tin calcine in different sections of tin smelting process into the powder material collecting bin for mixing and storage by means of quantitative pneumatic conveying; in a smelting stage of tin smelting, charging a bottom material into the cylindrical furnace body, melting the top blown furnace spray gun to form a molten pool, setting a conveying amount per unit time for the powdery materials stored in the powder material collecting bin through the DCS control system, providing kinetic energy by quantitative pneumatic conveying device, uniformly conveying to the powder material feeding nozzles through the branch conveying pipe, and then spraying into the cylindrical furnace body through the powder material inlet nozzles for smelting; charging other tin-containing materials, solvents and reduced coals into the cylindrical furnace body through a belt feeding inlet on the furnace top cover; stop feeding, entering a reduction stage, start judging the tin and slag discharging stages, and judging a degree of smelting by analyzing slag samples taken by the furnace top sample rod in the smelting process.

Preferably, the top-blown furnace spray gun melts to form a molten pool, and the feeding is performed when the depth of the molten pool is more than or equal to 500 mm.

Preferably, while the quantitative pneumatic conveying device is used to convey the powdery material into the cylindrical furnace body, the top blowing furnace lance continuously provides heat to the cylindrical furnace body at the melting lance position.

Preferably, after adding water to the other tin-containing materials, the solvent and the reduced coal, the tin-containing materials are put into the cylindrical furnace body through a belt conveying feeding port provided on the top cover of the furnace, continue smelting until the total amount of materials input reaches the set value of single melting amount in the top blown furnace and the sample rod at the top of the furnace cannot detect raw meal.

Preferably, in the process of stopping the feeding and entering the reduction stage, the powder material inlet nozzle stops and stops conveying the powder material into the furnace, but the powder material inlet nozzle continuously carries the material air, in order to prevent powdery materials from bee blocked by slag splashing into the furnace nozzle, spray into the furnace at the lowest air flow rate, the spray gun of the top blowing furnace is raised to the position of the reduction lance, and the belt convey the feed inlet continues to input the return coal.

Preferably, after reduction for a period of time, the furnace top sample rod takes a slag sample for analysis and sends it for analysis; if the tin content in the slag is less than 5%, it starts to release tin and slags, and the released coarse tin is sent to the refining process for treatment, and the slag is fumed to recover tin.

According to the technical scheme, compared with the prior art, the disclosure has the following beneficial effects:

The disclosure provides a side-type powder top blown furnace and method for treating the top blown furnace. In the present disclosure, powdery tin calcine produced by desulfurization in fluidized roasting furnace, powdery tin dust produced by fuming and enriching tin middlings and tin slag in fuming furnace, powdery tin dust collected in waste heat boiler and electric dust collector of flue gas treatment system in the process of top-blown furnace smelting, and several kinds of tin-containing powdery materials from different sources in tin smelters are directly and uniformly sent from the side wall of cylindrical furnace body through pneumatic conveying formula to be smelted, and does not naturally fall into the molten pool through the belt conveying inlet opened on the top cover of the furnace. Different powdery tin materials are collected in proportion and transported by a fixed amount of pneumatic conveying at the same time, so that the mixing process can be completed by airflow disturbance in the powdery material collecting bin, and the powdery tin materials can be rapidly smelted.

In the whole conveying process of the side-type powder top blown furnace provided by present disclosure for feeding powder, the close connection between the silo and the silo is realized, the conveying process of pow is simplified, and the flying loss in the conveying process of powder is avoided, which greatly improves the operating environment for employees. The pow of different sources at the top of the pow collecting bin is provided with a separate feed port of the powder collecting bin, and the conveying flow of different pow can be adjusted according to the production requirement, in addition, the disclosure realize the uniform mixing process of different powder materials in the powder material collecting bin by airflow disturbance according to the proportion, and is convenient for accurate control and production management of smelt powder materials.

During the conveying process, the powder is evenly diverted to the four powder feeding nozzles of the furnace body through the diversion pipeline, so that the material flow is dispersed into the furnace from different directions, and the furnace agglomeration caused by raw meal accumulation is not easy to occur during the powder feeding process; the symmetrical arrangement of the nozzles also reduces the impact and wear of the carrier gas flow on the furnace wall and has a positive effect on the protection of the furnace lining; the nozzle is arranged obliquely downward, and the intersection point of the jet is located at the slag liquid level position of the maximum treatment capacity of the single furnace, so that the nozzle is not only far away from the high-temperature smelt zone to a certain extent, in addition, the gas flow of the carry materials can stir the molten bath with the same force as the furnace body spray gun.

In the process of smelting tin in the top blow furnace, the feeding mode of the powdery tin-containing material is changed. Instead of the way of feeding after granulation, which needs to be transferred to the cylinder mixer by belt conveying feed port, the powder tin-containing material is directly sprayed into the molten pool by pneumatic conveying at high speed. It not only greatly avoids the phenomenon of low direct yield of tin smelting caused by a large number of powdery materials entering the dust collection system when feeding from the top of the furnace, but also reduces the amount of water input, saves the process of dust granulation, simplifies the feeding process of powdery tin materials, reduces the difficulty of subsequent flue gas treatment of the top blown furnace system, and also plays a positive role in improving the treatment capacity of the top blown furnace. In addition, the powder injected into the furnace is proportionally mixed with pulverized coal as fuel in the powder material collecting bin, so that the powder is gradually melted by combustion of the pulverized coal in the process of injection, and the melting efficiency of the top blowing furnace is further improved.

### BRIEF DESCRIPTION OF THE DRAWINGS

In order to more clearly explain that embodiments of the present disclosure or the technical scheme in the prior art, the following brief description will be given of the drawings which are necessary for the description of the embodiment or the prior art, and it will be apparent that, the drawings in the following description are merely embodiments of the present disclosure, and for those skilled in the art, other drawings may be obtained on the basis of the provided drawings without any creative effort.

FIG. 1 is schematic diagram of the structure of the side-type powder top blown furnace provided by the present disclosure;

In the drawing: 1—cylindrical furnace body, 2—powder material inlet nozzles (2), 3—furnace top sample rod, 4—top blown furnace spray gun, 5—belt feeding inlet, 6—branch conveying pipe, 7—quantitative pneumatic conveying device, 8—powder material collecting bin, 9—powder collecting bin feeding inlet, 10—furnace top cover.

### DETAILED DESCRIPTION OF THE EMBODIMENTS

The technical solutions in the embodiments of the present disclosure will be described clearly and completely in the following, and it is obvious that the illustrated embodiments are only a part of the embodiments of the present disclosure, but not all of the embodiments. Based on the embodiments of the present disclosure, all other embodiments obtained by the ordinary person skilled in the art without creative labor fall within the scope of protection of the present disclosure.

### Embodiment 1

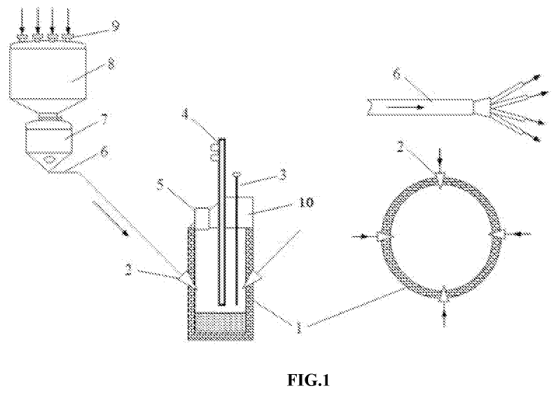

The embodiment 1 of the disclosure provides a method for treating a side-type powder top blown furnace, the side-type powder top blown furnace is shown in FIG. 1, and the working flow of the side-type powder top blown furnace is as follows:

in the tin smelting system, the powdered tin calcine produced by desulfurization in fluidized roaster is Sn 35 wt. %, S 1.1 wt. %, As 0.8 wt. %, H₂O≤3 wt. %, the powdered tin dust produced by fuming enriched tin middlings and tin slag in the fuming furnace is Sn 45 wt. %, Pb 0.2 wt. %, S 0.9 wt. %, As 1.5 wt. %, Fe 2 wt. %, H₂O≤4.5 wt. %, in the process of top-blown furnace smelting, the powdered tin dust collected in the waste heat boiler and electric precipitator of the flue gas treatment system is Sn 38 wt. %, Pb 1.0 wt. %, S 0.75 wt. %, As 1.8 wt. %, Fe 3 wt. %, H₂O≤4.5 wt. %, and other powdered tin materials and pulverized coal from different sources in several tin smelters, the quantitative pneumatic convey device is simultaneously fed into the powder material collecting bin 8 to complete the mixing, wherein the proportion of powdery tin baking sand is 40%, the proportion of dust of powdery fuming furnace is 30%, the proportion of dust of powdery top blowing furnace is 20%, and fine coal accounts for 10%.

In the feeding stage of ϕ 5 m top blown furnace, firstly, the material is fed into the bottom material by the belt feeding inlet 5, and then the bottom material is melted by the top blown furnace spray gun 4 to form a molten pool, when the depth of the molten pool reaches 500 mm, the normal feeding stage begins. The conveying pressure of the quantitative pneumatic conveying device 7 is adjusted to be 0.7 MPa, and the unit conveying amount is 30 t/h, after the material flows through the branch conveying pipe 6, the powder material is injected into the molten pool through four nozzles 2, respectively. Other materials containing tin ≥35 wt. %, returning raw coal and solvent are mixed, the feeding speed is controlled by DCS control system, the belt feeding inlet 5 is transported by belt and put into the furnace, and the whole feeding is over the range, and the top blown furnace spray gun 4 are in the melting lance position to continuously provide heat to the furnace.

When the accumulated amount of all tin-containing materials reaches 90 t, the single feeding process is finished, the pneumatic conveying and feeding of powdered tin materials and the belt feeding inlet 5 feeding of other tin materials are stopped, and the top blowing furnace enters the smelting stage. However, the nozzle is still in the spraying state without loading material, and the spraying air volume is adjusted to the minimum value. In the smelting process, the reduced raw coal is continuously put into the furnace to maintain the reducing atmosphere by controlling the feeding rate of the belt feeding inlet 5, and the furnace top sample rod 3 is placed at certain intervals, and the opportunity to enter the strong reduction stage is determined by observing the slag sample entrained with raw materials by the furnace top sample rod 3. In the strong reduction stage, increase the input amount of return coal, after reduction for a certain period of time, take slag samples from the furnace top sample rod 3 at the bottom of the furnace top, rapidly analyze the tin content in the slag, and when the Sn content of the slag sample taken out is less than 5%, enter the tin releasing stage, after the single-furnace smelting process is completed, the next furnace period is entered.

### Embodiment 2

The embodiment 2 provided by the present disclosure provides a method for side-feeding powder into a top-blowing furnace, and the working flow is as follows:

in the tin smelting system, the powdered tin calcine produced by desulfurization in fluidized roaster is Sn 38 wt. %, S 0.86 wt. %, As 1.0 wt. %, H₂O≤2 wt. %, the powdered tin dust produced by fuming rich tin middlings and tin slag in the fuming furnace is Sn 42 wt. %, Pb 0.5 wt. %, S 0.8 wt. %, As 2.0 wt. %, Fe 3.5 wt. %, H₂O≤4.0 wt. %, in the process of top-blown furnace smelting, the powdered tin dust collected from waste heat boiler and electric precipitator of flue gas treatment system includes Sn 40 wt. %, Pb 2.1 wt. %, S 0.68 wt. %, As 1.5 wt. %, Fe 3.6 wt. %, H₂O≤5 wt. %, and other powdered tin materials and pulverized coal from different sources in several tin smelters, in the disclosure, the correspond quantitative pneumatic conveying device is simultaneously fed into the powdery material collect bin 8 to complete the mixing, wherein the powdery tin calcine accounts for 45%, the powdery fuming furnace dust 25%, and the powdery top blowing furnace dust 22%, pulverized coal accounts for 8%.

In the feeding stage of ϕ 5 m top blown furnace, firstly, the material is fed into the bottom material by the belt feed inlet 5, and then the bottom material is melted by the top-blown furnace spray gun 4 to form a molten pool, when the depth of the molten pool reaches 500 mm, the normal feeding stage begins. The conveying pressure of the quantitative pneumatic conveying device 7 is adjusted to be 0.8 MPa, and the unit conveying amount is 20 t/h, after the material is divided by the branch conveying pipe 6, the powder material is injected into the molten pool through four injection nozzles 2. Other materials containing tin ≥35 wt. %, returning raw coal and solvent are mixed, the feeding speed is controlled by DCS control system, the belt feeding inlet 5 is transported by belt and put into the furnace, and the whole feeding is over the range, and the top blown furnace spray gun 4 are in the melting lance position to continuously provide heat to the furnace.

When the accumulated amount of all tin-containing materials reaches 60 t, the single feeding process is finished, the pneumatic conveying and feeding of powdered tin materials and the belt feeding inlet 5 feeding of other tin materials are stopped, and the top blowing furnace enters the smelting stage. However, the spray nozzle is still in the spray state of no load, and the spray air volume is adjusted to the minimum value. In the smelting process, the reduced raw coal is continuously put into the furnace to maintain the reducing atmosphere by controlling the feeding rate of the belt feeding inlet 5, and the furnace top sample rod 3 is placed at certain intervals, and the opportunity to enter the strong reduction stage is determined by observing the slag sample entrained with raw materials by the furnace top sample rod 3. In the strong reduction stage, increase the input amount of return coal, after reduction for a certain period of time, take slag samples from the furnace top sample rod 3 at the bottom of the furnace top, rapidly analyze the tin content in the slag, and when the Sn content of the slag sample taken out is less than 5%, enter the tin releasing stage, and the single-furnace smelting process is completed, then enter the next furnace period.

The foregoing description of the disclosed embodiments enables those skilled in the art to make or use the present disclosure. Many modifications to these embodiments will be obvious to those skilled in the art, and the general principles defined herein can be implemented in other embodiments without departing from the spirit or scope of the present disclosure. Therefore, the present disclosure will not be limited to the embodiments shown herein, but should be accorded the widest scope consistent with the principles and novel features disclosed herein.

What is claimed is:

1. A side-type powder top blown furnace, comprising: a cylindrical furnace body (1), powder material inlet nozzles (2), a furnace top sample rod (3), a top blown furnace spray gun (4), a belt feeding inlet (5), a branch conveying pipe (6), a quantitative pneumatic conveying device (7), a powder material collecting bin (8), a powder collecting bin feeding inlet (9) and a furnace top cover (10);
the powder material inlet nozzles (2) are symmetrically arranged around a furnace wall of the cylindrical furnace body (1) on the same horizontal plane, and the powder material inlet nozzles (2) are at an angle of 45 degrees with the furnace wall, and the center of the nozzle faces the center line of the furnace bottom;
the top of the cylindrical furnace body (1) is provided with a furnace top cover (10), the top blown furnace spray gun (4) passes through the center of the furnace top cover (10) and extends into the bottom of the cylindrical furnace body (1);
the furnace top sample rod (3) extends into the bottom of the cylindrical furnace body (1) through the furnace top cover (10);
the belt feeding inlet (5) is arranged on the furnace top cover (10);
the top of the powder material collecting bin (8) is provided with a powder material collecting bin feeding inlet (9), and the bottom of the powder material collecting bin (8) is connected with the quantitative pneumatic conveying device (7), the quantitative pneumatic conveying device (7) is connected with the powder material inlet nozzle (2) through the branch conveying pipe (6).

2. The top blown furnace of claim 1, wherein the vertical positions of the two symmetrically opposite corresponding nozzles of the powder material inlet nozzles (2) are arranged on the horizontal plane of the slag line with the maximum treatment capacity of the top blown furnace.

3. The top blown furnace of claim 1, wherein the powder material collecting bin feeding inlet (9) receives the powdery tin material and the fine coal of different sections in different sections in the tin smelting process, and the powder material collecting bin feeding inlet (9) respectively corresponds to the powdery materials of different sources.

4. The top brown furnace of claim 1, wherein the powder material collecting bin (8) is further provided with a DCS control system for setting an unit time and a conveying speed, and powdery materials are fed into the powder material collecting bin (8) of powdery materials by means of quantitative pneumatic conveying to complete mixing.

5. The top brown furnace of claim 1, wherein the conveying speed of the quantitative pneumatic conveying device (7) is 10-35 t/h and the conveying pressure is 0.6-0.9 MPa.

6. A method for treating a side-type powder top blown furnace, comprising:
setting parameters of DCS control system, feeding a powder tin dust, a powder coal and a powder tin calcine in different sections of tin smelting process into the powder material collecting bin (8) for mixing and storage by means of quantitative pneumatic conveying;
in a smelting stage of tin smelting, charging a bottom material into the cylindrical furnace body (1), melting the top blown furnace spray gun (4) to form a molten pool,
setting a conveying amount per unit time for the powdery materials stored in the powder material collecting bin (8) through the DCS control system,
providing kinetic energy by quantitative pneumatic conveying device (7),
uniformly conveying to the powder material feeding nozzles (2) through the branch conveying pipe (6), and then spraying into the cylindrical furnace body (1) through the powder material inlet nozzles (2) for smelting;
charging other tin-containing materials, solvents and reduced coals into the cylindrical furnace body (1) through a belt feeding inlet (5) on the furnace top cover (10);
stop feeding, entering a reduction stage, start judging the tin and slag discharging stages, and judging a degree of smelting by analyzing slag samples taken by the furnace top sample rod (3) in the smelting process.
